(19) United States
(12) Patent Application Publication
(10) Pub. No.: US 2026/0102766 A1
(43) Pub. Date: Apr. 16, 2026

(54) SAMPLE RECEPTACLE AND METHOD FOR PRODUCING A SAMPLE RECEPTACLE FOR CELL COUNTING

(71) Applicant: Ritter GmbH, Schwabmuenchen (DE)

(72) Inventor: Stefan SCHMUTTERMAIR, Langerringen (DE)

(21) Appl. No.: 19/356,822

(22) Filed: Oct. 13, 2025

(30) Foreign Application Priority Data
Oct. 14, 2024 (DE) 10 2024 129 635.6

(51) Int. Cl. B01L 3/00

(52) U.S. Cl. CPC B01L 3/502; B01L 2200/0647; B01L 2200/0684; B01L 2200/12; B01L 2300/041; B01L 2300/12

(57) ABSTRACT

A sample collection device 1 for collecting fluid, in particular for counting particles or determining the particle concentration in the fluid, in particular for determining biological cells, has two sample collection chambers 11 and 12 with a defined collection volume V. The sample collection chambers 11 and 12 each have a first opening 110, 120 for inserting the fluid into the respective chamber 11 or 12 and a vent opening 111 or 121. The sample collection device 1 consists of three components A, B, and C, wherein the third component C connects the first component A and the second component B.

### TECHNICAL FIELD

This application relates to a sample collection device for receiving fluid, in particular for counting particles or determining the particle concentration in the fluid, in particular for determining biological cells, comprising at least one sample collection chamber with a defined collection volume V. The invention also relates to a method of manufacturing a sample collection device, in particular as described above.

### PRIOR ART

Various methods, for example based on fluorescence, are used to determine the concentration of biological cells in a fluid. When counting the cells or determining the concentration, it is necessary to define and practically provide an exact fluid volume. For this purpose, sample collection devices made of plastics are provided with a sample chamber, a feed opening and possibly a vent outlet. The collection device usually has a plate-like structure with an embedded flat sample chamber. Plastics films (which may be coated) may be joined together, for example by laser welding, to define a sample chamber in the space between the films.

However, one challenge in plastics manufacturing is the high degree of accuracy required with regard to the volume of the sample chamber.

### OBJECT OF THE INVENTION

Based on this, one object of the present invention is to provide a sample collection device with sample chambers having a defined volume and a method for manufacturing the same.

### SUMMARY OF THE INVENTION

This object is attained by a sample collection device for receiving fluid, in particular for counting particles or determining the particle concentration in the fluid, in particular for determining the concentration of biological cells, and by a method for manufacturing the sample collection device according to claim 11 or 12. Advantageous embodiments result from the dependent claims.

A sample collection device according to the invention for receiving a fluid, in particular for counting particles or determining a particle concentration in the fluid, in particular for determining biological cells, comprising: at least one sample collection chamber (i.e. sample receiving chamber) with a defined collection volume (V); wherein the sample collection device comprises at least two assembled components, namely, a first component (A) and a second component (B), both of them manufactured as plastics parts, wherein the two components (A, B) delimit the sample collection chamber(s) (11, 12).

In particular, the sample collection chamber(s) each have a first opening for inserting the fluid into the respective chamber and possibly a second opening for venting.

In particular, a third component (C) is injection moulded onto the other two components as a connecting component in such a way that it comes into contact with the first component (A) and second component (B) and establishes a frictional connection, an adhesive bond connection and/or a form-fitting connection between the first component (A) and the second component (B).

In particular, the components A and B may be injection-moulded parts. However, alternatively components A and/or B may be stamped and/or embossed plastics films, which may be inserted into an injection mould and then be overmoulded.

In particular, the first component (A) is a plastics part, preferably an injection moulded part, with a base body and at least one trough-like recess formed in the upper side of the base body, the walls of which delimit the sample collection chamber.

The recess has, in particular, a predetermined depth T manufactured with high precision.

The second component (B) may comprise one or more plastics parts, preferably injection moulded parts, which cover the recesses of component (A).

The second component (B) may form one or more covers which cover the trough-like recesses.

In particular, the walls of the recesses and the cover(s) delimit the sample chamber(s).

The second component (B) is attached to the first component (A) by means of a further moulded or injection-moulded third component made of plastics, preferably an injection-moulded component (C).

The third component, optionally an injection-moulded component (C), may be attached to the surface of the first component (A), in particular by injection moulding into spaces between the second components (B) or into an area around the edge of the second component(s) (B).

The third component, optionally an injection-moulded component (C), may also be formed by injection moulding. The third component (C) may be inserted into one or more grooves formed in the second component (B), wherein the groove faces the surface of the first component (A) in which the recess is formed.

In a method according to the invention for manufacturing a sample collection device, in particular a sample collection device as described above, the following steps are carried out: (a) manufacturing of the first component A in a manufacturing process, preferably in an injection moulding process, (b) manufacturing the second component(s) B in a manufacturing process, preferably in an injection moulding process, (c) placing the second component(s) (B) to cover the opening(s) of the recesses of the first component (A), and (d) introducing the third component (C) into spaces located between the second components (B) or into an area around the edge of the at least one second component(s) (B) on the surface of the first component (A).

In a method according to the invention for manufacturing a sample collection device, in particular a sample collection device as described above, the following steps are carried out: (a) manufacturing the first component A in an extrusion or casting process, preferably in an injection moulding process, (b) manufacturing the second component(s) B in an extrusion or casting process, preferably in an injection moulding process, (c) placing the second component(s) (B) to cover the opening(s) of the recesses of the first component (A), wherein at least one groove, particularly a groove formed in the second component (B), faces the surface of the base body, and (d) inserting the third component (C) into the groove of the second component (B) onto the surface of the first component (A), wherein the insertion is preferably carried out via at least one hole connecting the groove to the exposed upper side of the second component (B).

In particular, the first component (A) and the second component(s) (B) are manufactured simultaneously in (the same) tool in process steps (a) and (b).

The sample collection device, which essentially consists of the three (3) components (A, B, and C), is manufactured in particular in a joining process using transfer technology, but at least in a single stage, preferably in a multi-component injection moulding process.

The sample collection device, which substantially consists of the three (3) components (A, B, and C), may be manufactured sequentially or in a multi-stage injection moulding process.

The components (A, B, C), in particular the first and second components (A, B), may be made of the same material, and/or the material of the third component (C) may be the same or different from the material of the first component (A) and/or the material of the second component (B).

### BRIEF DESCRIPTION OF THE DRAWINGS

Further features and advantages of the invention will become apparent from the following description with reference to the figures as follows:

FIG. 1 shows a perspective view of a sample collection device according to the invention;

FIG. 2 shows a top view and a sectional view A-A of a first embodiment of the invention;

FIG. 2A shows an enlarged portion of the sectional view of FIG. 1;

FIG. 3 shows a top view and a sectional view A-A of a second embodiment of the invention;

FIG. 3A shows an enlarged portion of the sectional view of FIG. 1;

FIG. 3B shows an enlarged section of the top view of FIG. 1;

FIG. 4 schematically shows a manufacturing method according to the invention.

### DESCRIPTION OF PREFERRED EMBODIMENTS OF THE INVENTION

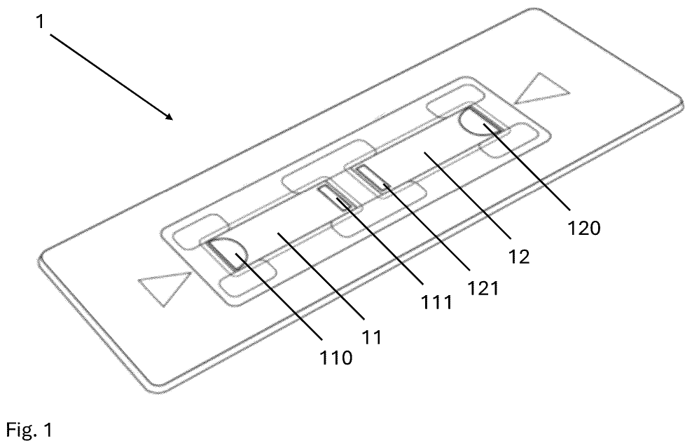

FIG. 1 shows a sample collection device 1 for receiving a fluid, in particular for counting particles or determining the particle concentration in the fluid, in particular for determining biological cells. The sample collection device 1 may be used as a microscope slide for cell counting.

The exemplary device 1 has two sample collection chambers 11 and 12 with a defined collection volume V. The sample collection chambers 11 and 12 each have a first opening 110, 120 for inserting fluid into the respective chamber 11 or 12, and a vent opening 111 or 121.

The number of chambers is not limited to two; a device may have only one or several chambers.

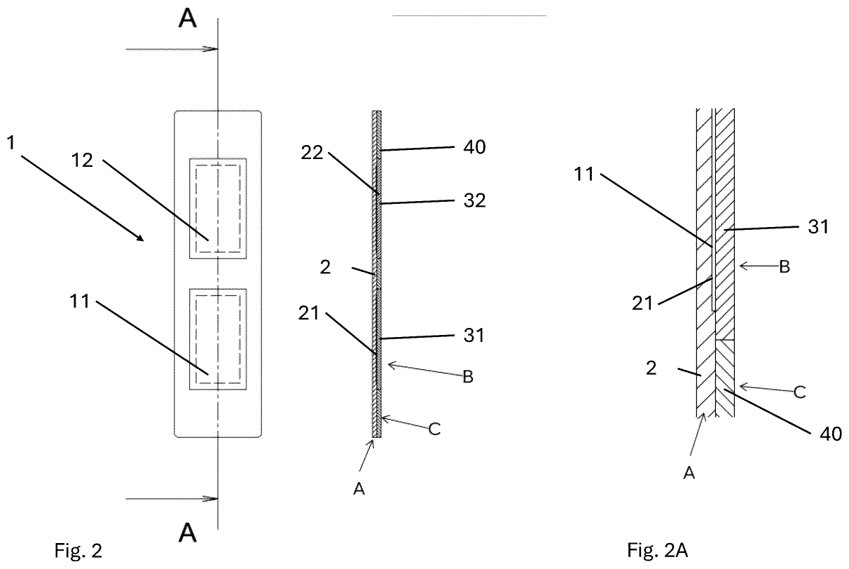

FIGS. 2 and 2A show a first embodiment of a sample collection device 1 as described above. For the sake of simplicity, the openings are not shown.

The sample collection device 1 is made of three (3) plastics components A, B and C.

The plastic components A and B are generally rigid. Component A is a relatively flat injection moulded part with a base body 2 and two trough-like recesses 21, 22 formed in the upper side of the base body 2, which define the sample collection chambers 11 and 12.

The recesses 21, 22 have a predetermined depth T, for example 95 mm, which is manufactured with high precision.

Component B is or consists of one or more flat injection moulded parts 31, 32, which form ‘windows’ that cover the recesses 21, 22 of the first component A. In the case of FIG. 2, there are two injection moulded parts or covers 31, 32 which cover the trough-like recesses 21 and 22. The walls of the recesses 21, 22 and the covers 31, 32 delimit respective sample chambers 11 and 12. The surface area of the covers 31, 32 is smaller than the surface area of the base body 2, but larger than the openings of the recesses 21, 22, so that they protrude beyond the edge of the openings of the recesses 21, 22 and rest there. As a rule, at least one first opening for introducing fluid (not shown) is formed in each of the covers 31, 32. The plastic component(s) B is/are transparent (at least to a certain degree) in order to enable optical counting methods to be carried out. In particular, additives required for the measuring process may be incorporated in plastic component A. This may eliminate the need for a potentially necessary step of coating the plastics.

The detailed illustration in FIG. 2A shows a recess 21 and the associated cover 31.

Component B is attached to the first component A by means of a further injection-moulded component C. In the first embodiment, the covers 31, 32 (components B) are arranged at right angles to each other on the surface of the base body 2. The additional component C, which connects components A and B (and C), is now inserted between the covers 31 and 32 by injection moulding (e.g. in a 2-component (2K) or multi-component injection moulding process) onto the surface of the base body 2. The third component C forms a connecting component 40. The connection may be an adhesive bond (e.g. composite injection moulding for thermodynamically compatible plastics A-C and B-C) or a form-fitting connection (e.g. assembly injection moulding for incompatible plastics A-C and/or B-C).

In a first manufacturing process, the following steps are carried out: (a) manufacturing a first component A in an injection moulding process, (b) manufacturing one or more second components B in an injection moulding process, (c) placing the component(s) B to cover the openings of recesses 21 and 22 of the first component A, and (d) introducing a third component C into the spaces between second components B or into an area around the edge of the second component(s) B on the surface of the first component A. Inserting the third component C connects components A, B and C.

The exposed surface of the third component C may be formed flush with the exposed surface of the second component B.

The sample collection device 1 may be manufactured from a total of three (3) components in a multi-component injection moulding process. The design and manufacturing process ensure precise production of the sample volumes V.

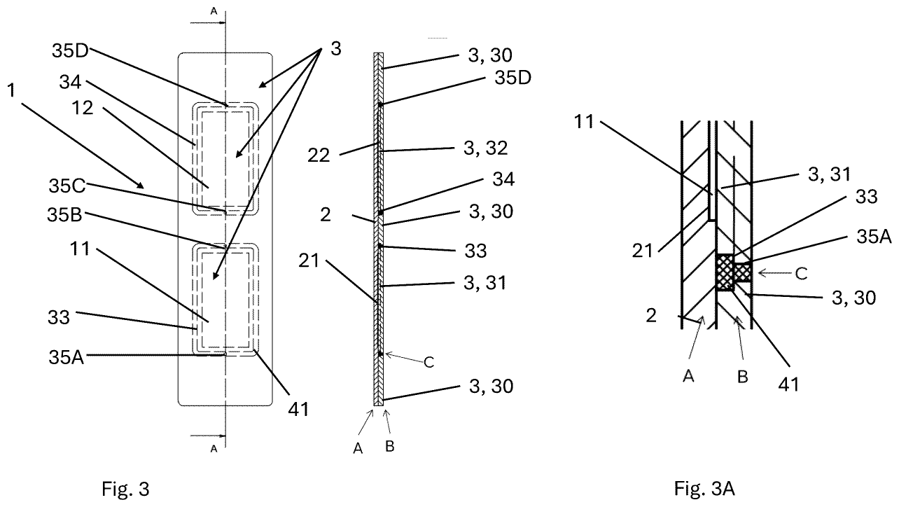

FIGS. 3 and 3A show a second embodiment of the invention, wherein the same features/components are designated with the same reference numerals as in the first embodiment. In contrast to the first embodiment, the second component B is not designed in the form of individual plate-like covers lying next to each other on the first component A, but as a continuous element or continuous plate 3 of approximately the same size as the surface of the base body 2. However, the plate 3 is divided into two cover areas 31, 32 by two grooves 33, 34 facing the surface of the base body 2, similar to the first embodiment, and an edge plate area 30 that surrounds the cover areas 31, 32. The grooves 33, 34 extend around the cover areas 31 and 32, respectively. Through holes 35A-35D are arranged at specific locations of the grooves, connecting the grooves to the exposed surface of the second component B.

This is shown in an enlarged view in FIG. 3B. FIG. 3B shows the upwardly exposed hole 35A and the groove 33 below it formed in the plate 3. Grooves 33, 34 are formed in the plate 3, which are connected to the outside by small holes 35A-35C through which component C in the form of a connecting component 41 is inserted or injection moulded. The connection is similar to the connection described in relation to the first embodiment.

The process for producing the second embodiment is also essentially the same as the process for producing the first embodiment of the sample collection device 1.

In a second manufacturing process, the following steps are carried out: (a) manufacturing the first component A in an injection moulding process, (b) manufacturing the second component(s) B in an injection moulding process, (c) placing the second component B to cover the openings of recesses 21 and 22 formed in the first component A, with grooves 33 and 34 facing the surface of the base body 2, and (d) inserting component C into the grooves 33, 34 of the second component B onto the surface of component A, whereby the insertion is carried out via holes 35A-35D which connect the groove 33 and 34, respectively, to the exposed upper side of the second component B. As the third component C contacts bothe the first and the second components A, B it connects components A, B and C.

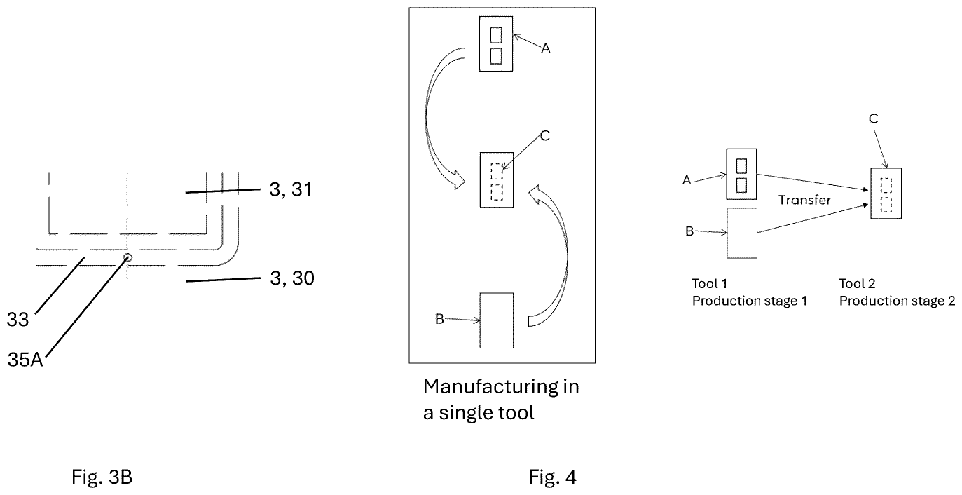

The first method is shown schematically in FIG. 4. The first component A and the second component B are manufactured in a first manufacturing step by injection moulding in a first mould. After cooling, the components A and B are superimposed (B is put on top of A) in a second manufacturing step and connected to each other by injecting component C into a second mould. The manufacturing process may be carried out sequentially or in a multi-stage injection moulding process.

Ideally, the first component A and the second component B are made of the same material. Material C may be made of the same material or of a material different from the material of components A and/or B.

1. A sample collection device for receiving fluid, in particular for counting particles or determining the particle concentration in the fluid, in particular for determining biological cells, comprising:
at least one sample collection chamber with a defined collection volume V;
wherein the sample collection device comprises at least a first component and at least a second component manufactured as plastics components and assembled to each other, in particular injection-moulded components, wherein the two components delimit the at least one sample collection chamber.

2. The sample collection device according to claim 1, wherein a third component is injection moulded as a connecting component in such a way that it comes into contact with the first component and the second component and establishes an adhesive fitting connection and/or a form-fitting connection between the first component and the at least one second component.

3. The sample collection device according to claim 1, wherein the first component is a plastics component, in particular an injection moulded part, with a base body and at least one trough-like recess formed in the upper side of the base body, wherein the walls of the recess delimit the sample chamber.

4. The sample collection device according to claim 1, wherein the recess has a predetermined depth T manufactured with high precision.

5. The sample collection device according to claim 1, wherein the second component comprises one or more plastics components, in particular injection moulded parts, which cover the recesses of the first component.

6. The sample collection device according to claim 1, wherein the second component forms one or more covers which cover the trough-like recesses.

7. The sample collection device according to claim 1, wherein the walls of the recesses and the covers delimit the sample collection chamber(s).

8. The sample collection device according to claim 1, wherein the second component is attached to the first component by a further injection-moulded third component.

9. The sample collection device according to claim 8, wherein the third injection-moulded component is attached to the surface of the first component by injection moulding into spaces between the second components or into an area around the edge of the second component(s).

10. The sample collection device according to claim 8, wherein the third injection-moulded component is formed by injection moulding into one or more grooves formed in the second component, wherein the groove faces the surface of the first component.

11. A method for manufacturing a sample collection device, particularly a sample collection device (1) according to claim 9, comprising the following steps: (a) manufacturing the first component, in particular by an injection moulding process, (b) manufacturing the second component(s), in particular by an injection moulding process, (c) placing the second component(s) to cover the opening(s) of the recess(es) formed in the first component, and (d) introducing the third component into the spaces between the second components or into an area around the edge of the second component(s) on the surface of the first component.

12. The method for manufacturing a sample collection device, particularly a sample collection device according claim 10, comprising the following steps: (a) manufacturing the first component, in particular using an injection moulding, (b) manufacturing the second component(s), in particular using an injection moulding process, (c) placing the second component(s) to cover the opening(s) of the recess(es) of the first component, wherein at least one groove faces the surface of the base body, and (d) inserting the third component into the groove of the second component onto the surface of the first component, wherein the insertion is preferably carried out via at least one hole connecting the groove to the exposed upper side of the second component.

13. The method according to claim 11, wherein the first component and the second component(s) are produced in steps (a) and (b) simultaneously in the same tool.

14. The method according to claim 11, wherein the sample collection device consisting essentially of the three components is manufactured in a multi-component injection moulding process.

15. The method according to claim 11, wherein the sample collection device consisting essentially of the three components is produced sequentially or in a multi-stage injection moulding process.

16. The method according to claim 11, wherein the components, in particular the first and second components, are made of the same material, and/or the material of the third component is the same as or different from the material of the first component and/or the second component.
